(19) United States
(12) Patent Application Publication
(10) Pub. No.: US 2025/0086469 A1
(43) Pub. Date: Mar. 13, 2025

(54) METHOD AND APPARATUS WITH VECTOR MAP LEARNING AND GENERATION

(71) Applicant: Samsung Electronics Co., Ltd., Suwon-si (KR)

(72) Inventors: Nayeon KIM, Suwon-si (KR); Sujin JANG, Suwon-si (KR); Dae Ung JO, Suwon-si (KR)

(73) Assignee: Samsung Electronics Co., Ltd., Suwon-si (KR)

(21) Appl. No.: 18/605,119

(22) Filed: Mar. 14, 2024

(30) Foreign Application Priority Data
Sep. 11, 2023 (KR) 10-2023-0120464

(51) Int. Cl. G06N 3/09

(52) U.S. Cl. CPC G06N 3/09

(57) ABSTRACT

A learning method of generating a vector map and a method and apparatus for generating a vector map are disclosed. The learning method includes converting a first feature extracted by inputting a first modality sensed by a first sensor to a student model into a first feature vector in a bird eye view (BEV) space, converting a second feature extracted by inputting a multi-modality including the first modality and a second modality sensed by a second sensor to a teacher model into a second feature vector in the BEV space, and learning the student model to generate a vector map corresponding to the first modality by back-propagating cross-correlation loss by dimension that causes the first feature vector to replicate a cross-correlation with the second feature vector to the student model.

### CROSS-REFERENCE TO RELATED APPLICATIONS

This application claims the benefit under 35 USC § 119(a) of Korean Patent Application No. 10-2023-0120464, filed on Sep. 11, 2023, in the Korean Intellectual Property Office, the entire disclosure of which is incorporated herein by reference for all purposes.

### BACKGROUND

### 1. Field

The following description relates to a method and apparatus with vector map learning and generation.

### 2. Description of Related Art

Neural network computing architectures may model machine-learned information in various ways. As neural networks advance in sophistication, electronic devices in various fields may employ neural network models to analyze input data and extract and/or generate valid information. For example, technologies for generating maps based on ordinary cameras have an advantage over methods using a lidar and multiple sensors, which are generally notably more expensive. Such camera-based systems may be used for various vision-based systems. However, because primarily (and sometimes only) two-dimensional (2D) information is used in camera-based systems, the expression/representation of three-dimensional (3D) physical elements in camera-based maps may be less accurate than lidar-based maps. In addition, technology for generating a map using both a camera and lidar may improve the accuracy of predicting physical elements by providing richer information than the technology using only a camera or only lidar. However, such technology is expensive because two or more sensors need to be used, and since the output of the neural network model is generated through two paths, the technology may be slow and not suitable for real-time inference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a model learning method of generating a vector map is performed by one or more processors and includes: extracting a first feature by inputting a first modality sensed by a first sensor to a student model that infers the first feature from the first modality, and converting the first feature into a first feature vector in a bird's eye view (BEV) space; extracting a second feature extracted by inputting a multi-modality to a teacher model that infers the second feature from the modality, and converting the second feature into a second feature vector in the BEV space, wherein the multi-modality includes the first modality and a second modality sensed by a second sensor; and teaching the student model to generate a vector map corresponding to the first modality by back-propagating cross-correlation loss by dimension, which causes the first feature vector to replicate a cross-correlation with the second feature vector to the student model.

The teaching of the student model may include repeatedly back-propagating the cross-correlation loss that causes a first correlation between the first feature vector and the second feature vector to be greater than a reference value in response to a dimension of the first feature vector and a dimension of the second feature vector being the same and that causes a second correlation between the first feature vector and the second feature vector to be less than the reference value in response to the dimension of the first feature vector and the dimension of the second feature vector being different.

The teaching of the student model may further include repeatedly back-propagating either (i) a first ground truth (GT) loss between a first output instance of the student model and a first GT instance corresponding to the first modality or (ii) a second GT loss between a second output instance of the teacher model and a second GT instance corresponding to the multi-modality to the student model.

The method may further include augmenting the first feature vector or the second feature vector, wherein the teaching of the student model may include back-propagating the cross-correlation loss by dimension to the student model so that the augmented first feature vector replicates a cross-correlation with the augmented second feature vector.

The augmenting may include augmenting the first feature vector or the second feature vector using a drop-out layer or random Gaussian noise.

The back-propagating of the cross-correlation loss by dimension to the student model may include: first-concatenating the first feature vector with the augmented first feature vector; second-concatenating the second feature vector with the augmented second feature vector; and back-propagating the cross-correlation loss by dimension to the student model so that the first-concatenated feature vector replicates a cross-correlation with the second-concatenated feature vector.

Each of the first feature vector and the second feature vector may include a row corresponding to the dimension and a column corresponding to an instance.

The first modality and the second modality may be input in synchronization with each other.

The first sensor may include a camera sensor, and the second sensor may include a lidar sensor.

In another general aspect, a method, performed by one or more processors, of generating a vector map, includes: accessing a first modality sensed by a first sensor; extracting a first feature from the first modality and converting the first feature into a first feature vector in a bird's eye view (BEV) space; and generating the vector map, which corresponds to the first modality, by applying the first feature vector to a learned neural network model, wherein the neural network model has been learned based on cross-correlation loss by dimension, which causes the first feature vector to replicate a cross-correlation with a second feature vector corresponding to a second feature extracted by inputting, to a teacher model, a multi-modality including the first modality and a second modality sensed by a second sensor.

The neural network model may be learned by repeatedly back-propagating the cross-correlation loss, which causes a first correlation between the first feature vector and the second feature vector to be greater than a reference value, in response to a dimension of the first feature vector and a dimension of the second feature vector being the same and a second correlation between the first feature vector and the second feature vector to be less than the reference value in response to the dimension of the first feature vector and the dimension of the second feature vector being different.

The neural network model may be further learned by repeatedly back-propagating either (i) a first ground truth (GT) loss between a first output instance of the neural network model and a first GT instance corresponding to the first modality or (ii) a second GT loss between a second output instance of the teacher model and a second GT instance corresponding to the multi-modality.

The first modality and the second modality may be input in synchronization with each other.

The first sensor may include a camera sensor, and the second sensor may include a lidar sensor.

Each of the first feature vector and the second feature vector may include a row corresponding to the dimension and a column corresponding to an instance.

The first modality may include a color image and the second modality may include a point cloud.

In another general aspect, an apparatus for generating a vector map includes: one or more processors; and memory storing instructions configured to cause the one or more processors to: convert a first feature extracted from a first modality into a first feature vector in a bird's eye view (BEV) space, and generate a vector map corresponding to the first modality by applying the first feature vector to a learned neural network model, wherein the neural network model has been learned based on cross-correlation loss by dimension, which causes the first feature vector to replicate a cross-correlation with a second feature vector corresponding to a second feature extracted by inputting, to a teacher model, a multi-modality including the first modality, which is sensed by a first sensor, and including a second modality sensed by a second sensor.

The neural network model may be learned by repeatedly back-propagating the cross-correlation loss, which causes (i) a first correlation between the first feature vector and the second feature vector to be greater than a reference value in response to a dimension of the first feature vector and a dimension of the second feature vector being the same and causes (ii) a second correlation between the first feature vector and the second feature vector to be less than the reference value in response to the dimension of the first feature vector and the dimension of the second feature vector being different.

The neural network model, in addition to the cross-correlation loss, may be learned by repeatedly back-propagating either (i) first ground truth (GT) loss between a first output instance of the neural network model and a first GT instance corresponding to the first modality or (ii) a second GT loss between a second output instance of the teacher model and a second GT instance corresponding to the multi-modality.

The first sensor may include a camera sensor, and the second sensor may include a lidar sensor.

Other features and aspects will be apparent from the following detailed description, the drawings, and the claims.

### BRIEF DESCRIPTION OF THE DRAWINGS

FIG. 1 illustrates an example method of learning generation of vector maps, according to one or more embodiments.

FIG. 2 illustrates an example architecture for learning generation of vector maps, according to one or more embodiments.

FIG. 3A illustrates an example of a first feature vector and a second feature vector, according to one or more embodiments.

FIG. 3B illustrates an example of learning a student model by cross-correlation loss by dimension, according to one or more embodiments.

FIG. 4 illustrates an example of augmenting a feature vector when learning generation of vector maps, according to one or more embodiments.

FIG. 5 illustrates an example method of generating vector maps, according to one or more embodiments.

FIG. 6 illustrates an example method of generating vector maps, according to one or more embodiments.

FIG. 7 illustrates an example apparatus for generating vector maps, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

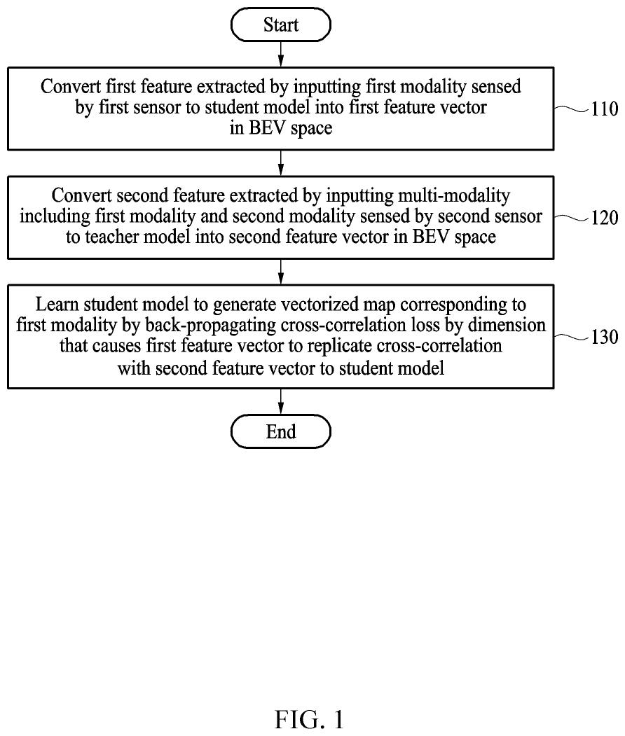

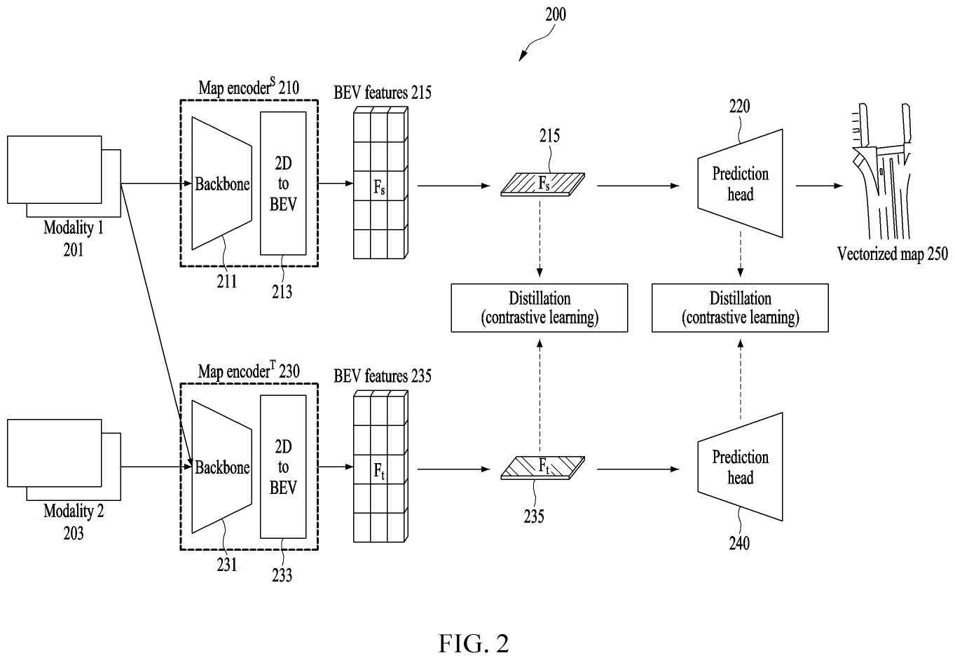

FIG. 1 illustrates an example method of learning vector map generation and FIG. 2 illustrates an example architecture for learning generation of vector maps, according to one or more embodiments.

Referring to FIGS. 1 and 2, a learning/computing apparatus 200 may learn a student model S 210 through operations 110 to 130. The student model S 210 may be configured for high-performance by having lightweight features (e.g., relatively low numbers of nodes and/or layers). The student model S 210 may be obtained from a teacher model T 230 configured for high-performance by having heavyweight (e.g., relatively high numbers of nodes and/or layers compared to the student model S 210); the student model S 210 may be obtained through a knowledge distillation technique of distilling knowledge from the more accurate teacher model T 220 (“high” and “low” are relative terms contrasting the teacher and student models and do not imply any particular quantity/value). In some embodiments, the student model S 210 and the teach model T 230 may have a same number of inputs (input nodes) at their respective input layers, and/or may have a same number output nodes at their respective output layers.

A neural network model (e.g., the student model S 210) (having high-performance and lightweight size) for estimating/predicting vector maps may be used when performing supervised learning in which road information (e.g., information on center lines and lanes, crosswalks, road boundaries, etc.) about the vicinity of a vehicle is given as a high-density (HD) map-based label or unsupervised learning in which a label is not given. That is, in some embodiments, supervised learning may be based on training data in which HD maps have labels indicating road information therein (e.g., labels of segmented objects). The student model S 210 may be taught to be able to meaningfully express the characteristics of the road information by replicating rich geometric information that it receives from the teacher neural model T 230.

The learning apparatus 200 may pre-learn the teacher model T 230 with a training process that minimizes the difference between a ground truth (GT) value and the output of the teacher model T 230 and may do so by a supervised learning method, and then may learn the student model S 210 so that the output of the student model S 210 mimics (closely replicates) the output of the teacher model T 230. As described below, the student model S 210 may replicate differential and/or similar features (sameness features or difference features) from a feature vector (e.g., a second feature vector) of the teacher model T 230 through contrastive learning and may be taught by sharing of the output value of the teacher model T 230.

The student model S 210 and the teacher model T 230 may each respectively include, for example, a backbone network 211 and a backbone network 231 that each extract a first feature and/or a second feature (two-dimensional (2D) backbone features) from input data (e.g., a first modality 201 and/or a second modality 203) and a conversion network 213 and a conversion network 233 that each convert the respective 2D backbone feature into a feature vector in a bird's eye view (BEV) space. Each of the student model S 210 and the teacher model T 230 may be, for example, a deep neural network (DNN), a convolutional neural network (CNN), a recurrent neural network (RNN), a restricted Boltzmann machine (RBM), and/or a deep belief network (DBN) but is not necessarily limited thereto. The term “first modality” may refer to an image (e.g., an RGB driving image captured by a vehicle camera, for example), the term “second modality” may refer to a 3D image (e.g., a point cloud captured by, e.g., a lidar), and the term “multi-modality” may refer to a first modality paired with a second modality.

The learning device may replicate to the student model S 210 rich geometric information from the teacher model T 230, thereby enabling the student model S 210 to learn better feature vectors about road information than a network model based on a single vector map that learns using images.

As described next, in operation 110, the learning apparatus may convert (i) the first feature (extracted by inputting the first modality 201 (sensed by a first sensor) to the student model S 210) into (ii) a first feature vector Fs 215 in a BEV space. The first sensor may be, for example, a camera sensor (e.g., a color camera, an infrared camera, etc.), but is not necessarily limited thereto. Specifically, the learning apparatus may forward, for example, an image I (e.g., a driving image of a vehicle) to the student model S 210. The output value of the middle layer of the student model S 210 to which the image I is forwarded may be denoted as Fₛ:=S(I)(“S” standing for “student”). The learning apparatus may convert the first feature into this first feature vector Fs 215 (which is in the BEV space) using, for example, an inverse perspective mapping (IPM) technique. IPM may remove a perspective effect from an input image (and/or a segmentation image) and convert location information of an image plane into location information of a world coordinate system (i.e., BEV coordinates).

As described next, in operation 120, the learning apparatus may convert (i) the second feature (extracted by inputting a multi-modality including the first modality 201 and the second modality 203 (sensed by a second sensor) to the teacher model T 230) into (ii) a second feature vector Ft 235 (in the BEV space). The teacher model T 230 may convert a 2D second feature into the second feature vector Ft 235 (in the BEV space). The learning apparatus may convert the second feature into the second feature vector Ft 235 (in the BEV space) using an IPM technique similar to that of the student model S 210. In some embodiments, a multi-modality includes a 2D image and a 3D image such as a point cloud.

Both (i) the student model S 210 converting the first feature (extracted from the first modality 201) into the first feature vector Fs 215 (in the BEV space) and (ii) the teacher model T 230 converting the second feature (extracted from the first modality 201 and the second modality 203) into the second feature vector F: 235 (in the BEV space) may be for learning based on cross-correlation loss by dimension that makes the dimension of the first feature vector Fs 215 and the dimension of the second feature vector Ft 235 to be the same and to replicate a cross-correlation.

The second sensor may be/include, for example, a lidar sensor but is not necessarily limited thereto (any three-dimension sensor(s), or sensor(s) whose data may be synthesized into point cloud data). The second sensor may be/include an inertial measure unit (IMU) sensor, a gyro sensor, and/or a wheel odometer. The learning apparatus may forward, for example, the image I (a driving image of a vehicle) and a lidar point cloud P (corresponding in time to the image I) to the teacher model T 230. Here, the image I may be a single image or multiple images. The output value of the middle layer of the teacher model T 230 (to which the image I and the lidar point cloud P are forwarded/inputted) may be defined as Fₜ=T(P,I).

The first modality 201 included in the multi-modality may be sensed by the first sensor or another sensor (possibly after some post-processing). The first modality 201 and the second modality 203 may be input in synchronization with each other. For example, when the first modality 201 is a driving image at a time point t, the second modality 203 may also correspond to the lidar point cloud P at the time point t.

The learning apparatus may learn so that the student model S 210 meaningfully expresses characteristics of road information by replicating rich geometric information from the teacher model T 230 (in particular, from the second modality) through a knowledge distillation technique between the first feature vector Fₛ 215 and the second feature vector Fₜ 235. In addition, the learning apparatus may replicate a cross-correlation with the first feature vector Fs 215 of the student model S 210 and the second feature vector Ft 235 of the teacher model T 230 using contrastive learning and may apply cross-correlation loss between feature vectors to reinforce differential feature information, as shown in Equation 1 below.

$${L}_{cl ( A , B ) = \sum {( 1 - {C}_{ii} )}^{2} + λ \sum \sum {C}_{ij}^{2}} \qquad Equation 1$$

Here, cl denotes “contrastive learning”, λ denotes a control constant. Cᵢᵢ denotes a correlation (‘a first correlation’) when the first feature vector Fₛ 215 of the student model S 210 and the second feature vector Fₜ 235 of the teacher model T 230 are positive classes having the same dimension value (dimension i). In addition, Cᵢⱼ denotes a correlation (‘a second correlation’) when the first feature vector Fₛ 215 of the student model S 210 has a dimension i and the second feature vector Fₜ 235 of the teacher model T 230 has a dimension value j, that is, when the first feature vector Fₛ 215 of the student model S 210 and the second feature vector Fₜ 235 of the teacher model T 230 are negative (different) classes having different dimension values.

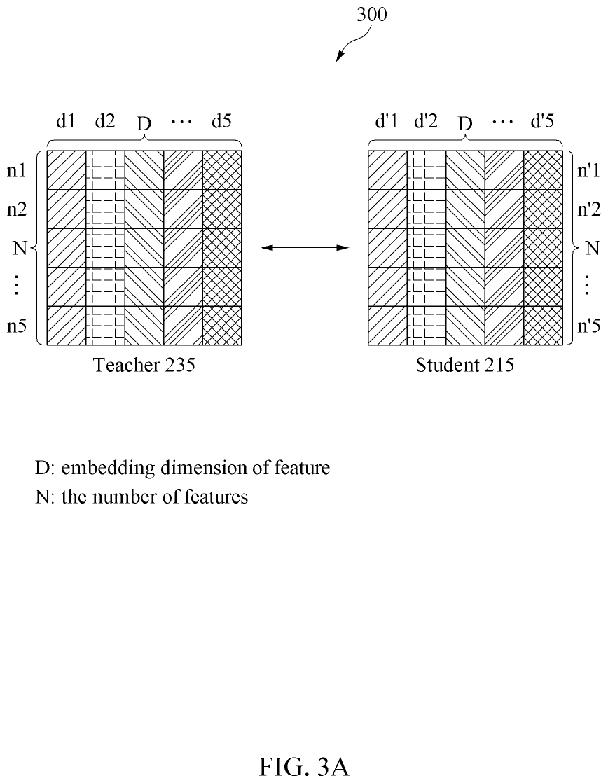

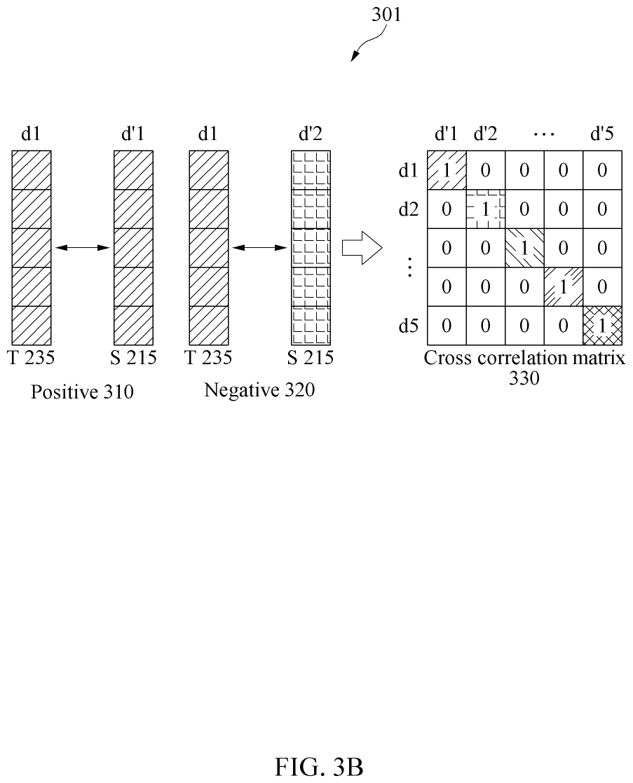

The learning apparatus may learn the student model S 210 so that the first correlation Cᵢᵢ increases when feature vectors are positive (same) classes and may learn the student model S 210 so that the second correlation Cᵢⱼ decreases when feature vectors are negative classes. That is, the cross-correlation loss may be minimized as the first correlation Cᵢᵢ approaches 1 and as the second correlation Cᵢⱼ approaches 0. Here, each of the first feature vector Fₛ 215 and the second feature vector Fₜ 235 may include a respective row corresponding to the dimension and a respective column corresponding to an instance (the term “instance” is defined later, but briefly, is an instance of an object). An example of the first feature vector Fₛ 215 and the second feature vector Fₜ 235 is described in more detail below with reference to FIG. 3A.

In operation 130, the learning apparatus may learn the student model S 210 to generate a vector map 250 corresponding to the first modality 201 by back-propagating cross-correlation loss by dimension that causes the first feature vector Fₛ 215 to replicate, to the student model S 210, a cross-correlation with the second feature vector Fₜ 235. The vector map 250 may include, for example, classes of map components, coordinates information of map components, and directions of map components. The map components may include, for example, road features (e.g., roads, lanes, traffic lights, curbs, crosswalks, roadside objects etc.) and the like in a high-resolution map or the vector map 250 but are not necessarily limited thereto. The vector map 250 may be output, for example, as a point cloud but is not necessarily limited thereto.

Regarding teacher-student knowledge distillation, the learning apparatus may train a neural network model in a self-supervised manner even when a label is not given by learning the student model S 210 using a clustering result on the teacher model T 230 to replicate the relative similarity between data points in an embedding space of the teacher model T 230.

The learning apparatus may learn the student model S 210 by repeatedly back-propagating the cross-correlation loss that (i) causes the first correlation (between the first feature vector Fₛ 215 and the second feature vector Fₜ 235) to be greater than a reference value when the dimension of the first feature vector Fₛ 215 and the dimension of the second feature vector Fₜ 235 are the same and that (ii) causes the second correlation between the first feature vector Fₛ 215 and the second feature vector Fₜ 235 to be less than the reference value when the dimension of the first feature vector Fₛ 215 and the dimension of the second feature vector Fₜ 235 are different. A method by which the learning apparatus learns the student model S 210 by such cross-correlation loss by dimension is described in more detail below with reference to FIG. 3B.

The learning apparatus may learn the student model S 210 through knowledge distillation based on contrastive learning between final output values of the respective student model S 210 and the teacher model T 230, rather than the output values of the middle layers of the student model S 210 and the teacher model T 230, that is, contrastive learning between the output instances output from each of a prediction head 220 of the student model S 210 and a prediction head 240 of the teacher model T 230, respectively.

For example, in addition to the cross-correlation loss, the learning apparatus may repeatedly back-propagate (i) first GT loss between a first output instance of the student model S 210 and a first GT instance corresponding to the first modality 201 and/or (ii) second GT loss between a second output instance of the teacher model T 230 and a second GT instance corresponding to the multi-modality 203 to the student model S 210. Here, the first output instance inferred by the student model S 210 may be output from the prediction head 220 of the student model S 210. The prediction head 220 may serve as a decoder that outputs the first output instance by decoding the first feature vector Fs 215. In addition, the second output instance inferred by the teacher model T 230 may be output from the prediction head 240 of the teacher model T 230. The prediction head 240 may serve as a decoder that outputs the second output instance by decoding the second feature vector Fₜ 235.

More specifically, contrastive learning performed between the prediction head 220 of the student model S 210 and the prediction head 240 of the teacher model T 230 may be performed as shown in Equation 1 described above. Similar to contrastive learning between related feature vectors, (1) when the first output instance of the student model S 210 and the second output instance of the teacher model T 230 are the same, the learning apparatus may determine classes of the feature vectors as positive classes (the same class), and (2) when the first output instance of the student model S 210 and the second output instance of the teacher model T 230 are different, the learning apparatus may determine classes of the feature vectors as negative classes, learning may proceed accordingly. Here, in the prediction heads 220 and 240, since the related output instances are compared with each other, not the feature vectors, the learning apparatus may first perform a comparison between GT values, that is, GT instances and output instances. The learning apparatus may determine which map components predicted by the learning apparatus match which map components of the GT value by comparing the output instance of the prediction heads 220 and 240 with the GT instance. Here, each of the student model S 210 and the teacher model T 230 may have matching information. Then, the learning apparatus may proceed with instance-wise contrastive learning between the student model S 210 and the teacher model T 230 based on each piece of matching information. The learning apparatus may know which instances each model predicts through a comparison with the above-described GT value. The learning apparatus may determine that the output instance of the teacher model T 230 is the same as which output instance of the student model S 210 based on the predicted instances. The learning apparatus may proceed with learning by (i) determining the class of the feature vectors as the above-described positive classes when the output instance of the teacher model T 230 is the same as the output instance of the student model S 210 and by (ii) determining the class of the feature vectors as above-described negative classes when the output instance of the teacher model T 230 is not the same as the output instance of the student model S 210.

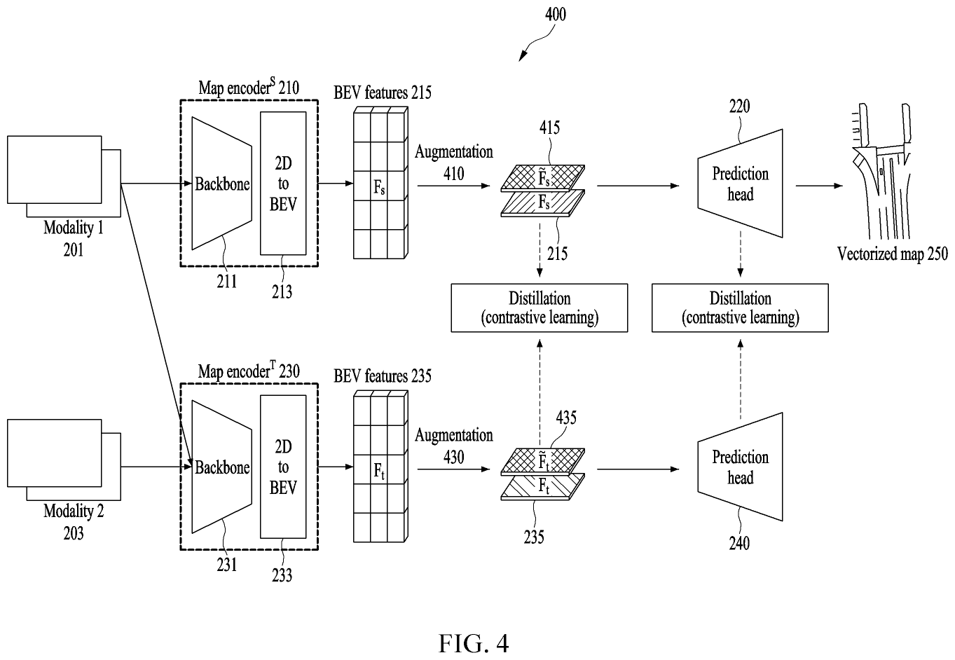

As described below with reference to FIG. 4, the learning apparatus may augment at least one of the first feature vector Fₛ 215 or the second feature vector Fₜ 235 for diversification of the feature vectors and may learn the student model S 210 using the augmented feature vectors.

FIG. 3A illustrates an example of a first feature vector and a second feature vector, according to one or more embodiments. Referring to FIG. 3A, diagram 300 illustrates an example of the first feature vector 215 and the second feature vector Fₜ 235.

The first feature vector Fs 215 may correspond to the student model S 210. The second feature vector Fₜ 235 may correspond to the teacher model T 230.

Each of the first feature vector Fₛ 215 and the second feature vector Fₜ 235 may include a row corresponding to a dimension D and a column corresponding to an instance. The dimension D represents a feature vector embedding dimension. N is the number of features represented by each feature vector, that is, the number of instances.

Here, an instance may correspond to an individual component of a high-resolution map or vector map. The instance may include, for example, map components such as roads, lanes, traffic lights, curbs, crosswalks, and the like but is not necessarily limited thereto. In addition, an instance may further include various objects included in a driving image of a vehicle.

As described above, when modalities used by the student model S 210 and the teacher model T 230 are different, the application of contrastive learning may be difficult. Accordingly, the classification performance of the student model S 210 may be improved by applying and learning cross-correlation loss by dimension rather than by instance when an object has sparse existence in the three-dimensional (3D) BEV space.

FIG. 3B illustrates an example of learning a student model by cross-correlation loss by dimension, according to one or more embodiments. Diagram 301 illustrates a cross correlation matrix 330 by cross-correlation loss by dimension.

Based on the above-described Equation 1, for example, when the content of a dimension d1 of the second feature vector Fₜ 235 and the content of a dimension d′1 of the first feature vector Fₛ 215 are the same positive classes 310, the learning apparatus may set, for example, a first correlation between the dimension d1 of the second feature vector Fₜ 235 and the dimension d′1 of the first feature vector Fₛ 215 to 1 in the cross correlation matrix 330. In addition, when the content of dimension d1 of the second feature vector Fₜ 235 and the content of a dimension d′2 of the first feature vector Fₛ 215 are different negative classes 320, the learning apparatus may set, for example, a first correlation between the dimension d1 of the second feature vector Fₜ 235 and the dimension d′1 of the first feature vector Fₛ 215 to 0 in the cross correlation matrix 330.

The learning apparatus may learn the student model S 210 by repeatedly back-propagating the cross-correlation loss based on the cross correlation matrix 330.

FIG. 4 illustrates an example of a method of augmenting a feature vector when learning for generating a vector map, according to one or more embodiments. Diagram 400 illustrates a process in which the learning apparatus may perform augmentation 410 on the first feature vector Fₛ 215 and perform augmentation 430 on the second feature vector Fₜ 235 in order to diversify feature vectors of each model. Hereinafter, the operation of the remaining parts except for the augmentation of the feature vector is generally the same as described above with reference to FIG. 2; different operations according to the augmentation of the feature vector are mainly described next.

The learning apparatus may augment at least one of the first feature vector Fₛ 215 or the second feature vector Fₜ 235. The learning apparatus may augment at least one of the first feature vector Fₛ 215 or the second feature vector Fₜ 235, using one or more of various augmentation techniques, for example, a drop-out technique, a random Gaussian noise technique, a crop technique, image rotation, scale adjustment, image movement, and color distortion.

The drop-out technique is a method of partially dropping or ignoring some nodes in an interconnected neural network model with a probability between 0 and 1 during learning, which may reduce overfitting of neural network models while diversifying output values. The random Gaussian noise technique may involve generating noise (e.g., random Gaussian noise) using a random function, and then diversifying output values by applying random Gaussian noise to layers of a neural network model. The crop technique may involve intentionally changing the viewpoint and size of the entire image. When the crop technique is used, the edge of an image may be adjusted close to the desired viewpoint by editing the subject or irrelevant parts of the subject at the outer boundary. The crop technique, image rotation, scale adjustment, image movement, and/or color distortion may be used, for example, when a modality is an image. As described above, the learning apparatus may augment feature vectors by applying different augmentation techniques according to the feature of each modality.

The first feature vector Fₛ 215 to which one or more of the above-described augmentation techniques are applied may be defined as an augmented first feature vector \tilde{F}ₛ (i.e., Augmentation Fₛ). In addition, the second feature vector Fₜ 235 to which various augmentation technique(s) are applied may be defined as an augmented second feature vector \tilde{F}ₜ (i.e., Augmentation Fₜ). The above-described augmentation techniques may be applied to the modality input to each model (e.g., the student model S 210 and/or the teacher model T 230) in addition to the feature vector.

The learning apparatus may back-propagate the cross-correlation loss by dimension to the student model S 210 so that the augmented first feature vector Fs replicates the cross-correlation with the augmented second feature vector \tilde{F}ₜ. The learning apparatus may first-concatenate the first feature vector Fₛ 215 with the augmented first feature vector Fₛ. The learning apparatus may second-concatenate the second feature vector Ft 235 with the augmented second feature vector \tilde{F}ₜ. The learning apparatus may back-propagate the cross-correlation loss by dimension to the student model S 210 so that the first-concatenated feature vector replicates the cross-correlation with the second-concatenated feature vector.

The learning apparatus may apply the cross-correlation loss between feature vectors as shown in Equation 1 and Equation 2 so that feature vectors Fₛ and \tilde{F}ₛ of the student model S 210 replicate the cross-correlation between feature vectors Fₜ and \tilde{F}ₜ of the teacher model T 230 using a contrastive learning technique and reinforce differential feature information.

$${L}_{cl} ( {F}_{s} {\tilde{F}}_{s} , {F}_{t} {\tilde{F}}_{t} ) , where means concat operation \qquad Equation 2$$

Here, Fₛ⊚\tilde{F}, denotes the concatenation between the augmented first feature vector \tilde{F}ₛadded by augmentation and the first feature vector Fₛ and Fₜ⊚\tilde{F}ₜ denotes the concatenation between the augmented second feature vector Ft added by augmentation and the second feature vector Fₜ.

L_{cl}(Fₛ⊚\tilde{F}ₛ, Fₜ ⊚\tilde{F}ₜ) denotes the cross-correlation loss between the first-concatenated feature vector of the student model S 210 and the second-concatenated feature vector of the teacher model T 230.

In addition, the learning apparatus may learn the student model S 210 using exponential magnitude similarity loss to reinforce the similarity between differential feature information and cross-correlation of magnitude values of feature vectors as shown in Equation 3.

$${L}_{ems} ( A , B ) = ‖ logits - target ‖ , \qquad Equation 3$$

$$where logits$$

$$= {e}^{- ( {‖ A ‖}_{2}^{2} + {‖ B ‖}_{2}^{2} - 2 A \cdot {B}^{T} ) / τ} , target = logits$$

$$= {e}^{- ( {‖ B ‖}_{2}^{2} + {‖ {B}^{T} ‖}_{2}^{2} - 2 B \cdot {B}^{T} ) / τ}$$

Here, T denotes a control constant. A denotes the first feature vector Fₛ 215 or the concatenation (‘the first-concatenated feature vector’) between the augmented first feature vector \tilde{F}ₛ and the first feature vector Fₛ 215. B denotes the second feature vector Fₜ 235 or the concatenation (‘the second-concatenated feature vector’) between the augmented second feature vector \tilde{F}ₜ and the second feature vector Fₜ 235. target denotes the correlation of the feature vectors Fₜ and \tilde{F}ₜ themselves of the teacher model T 230. logits denotes the correlation between the magnitude of the feature vectors Fₛ and Fₛ of the student model S 210 and the magnitude of the feature vectors Fₜ and \tilde{F}ₜ of the teacher model T 230.

Equation 3 may represent loss to increase the similarity (to minimize the difference) between the magnitude of the feature vectors Fₜ and \tilde{F}ₜ of the teacher model T 230 and the magnitude of the feature vectors Fₛ and \tilde{F}ₛ of the student model S 210.

The learning apparatus may provide a neural network model that may extract the first feature vector Fₛ 215 (which includes rich geometric information) without additional label information by generating a feature vector extractor (e.g., the student model S 210) that extracts the first feature vector Fₛ 215 with rich geometric information similar to the second feature vectors Fₜ and \tilde{F}ₜ of the teacher model T 230 through the above-described learning process.

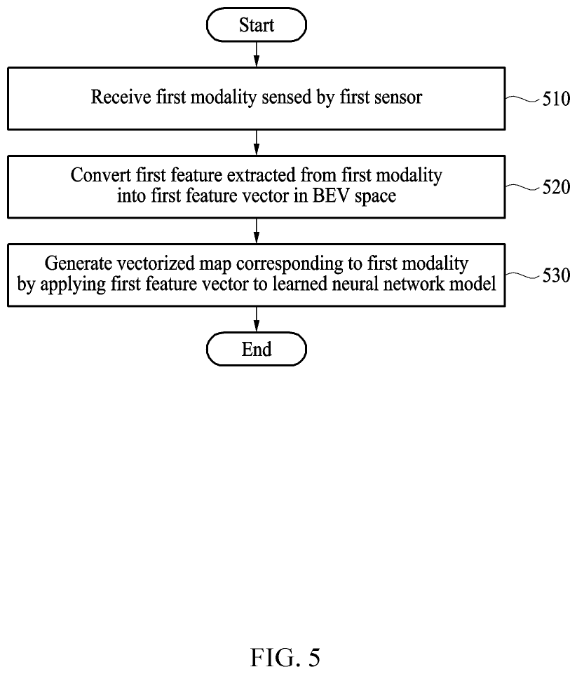

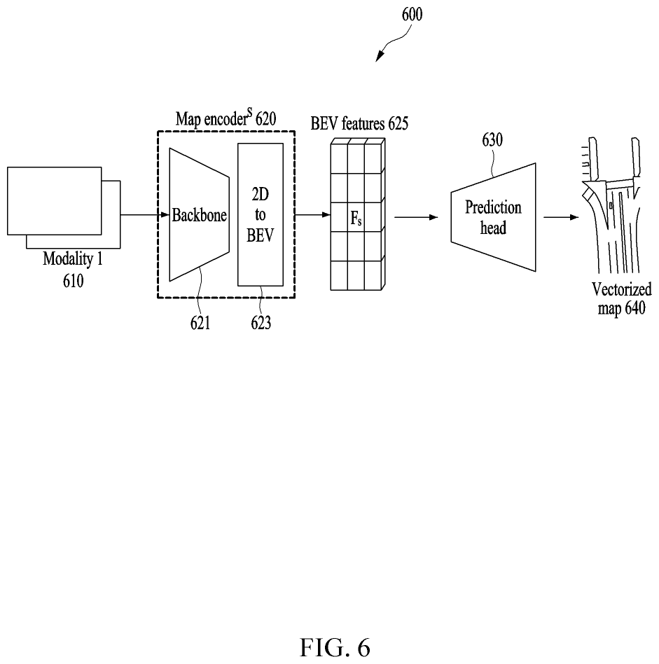

FIG. 5 illustrates an example of a method of generating a vector map and FIG. 6 illustrates an example of a method of generating a vector map, according to one or more embodiments.

Referring to FIGS. 5 and 6, an apparatus for generating a vector map (hereinafter, referred to as a ‘generation apparatus’) may generate a vector map corresponding to a first modality through operations 510 to 530.

In operation 510, the generation apparatus may receive a first modality 610 sensed by a first sensor.

In operation 520, the generation apparatus may convert a first feature extracted from the first modality 610 received in operation 510 into a first feature vector 625 in a BEV space. The generation apparatus may convert the first feature into the first feature vector 625 in the BEV space using a neural network model or may convert the first feature into the first feature vector 625 in the BEV space using a separate encoder. The neural network may have been trained as described above.

In operation 530, the generation apparatus may generate a vector map 640 corresponding to the first modality 610 by applying the first feature vector 625 from the conversion in operation 520 to a learned neural network model. Here, the neural network model may include, for example, a map encoder 620 and/or a prediction head 630. The map encoder 620 and the prediction head 630 may respectively correspond to the student model S 210 learned through the above-described learning process and the prediction head 220. The prediction head 220 may have been trained to infer vectorized maps from BEV feature vectors. The map encoder 620 may include a backbone network 621 that extracts the first feature 625 in 2D from the first modality 610 and a conversion network 623 that converts the first feature vector 625 in 2D into a feature vector in the BEV space. The backbone network 621 may correspond to, for example, an encoder and the prediction head 630 may correspond to a decoder.

The neural network model may be learned based on cross-correlation loss by dimension, which causes a first feature vector to replicate a cross-correlation with a second feature vector corresponding to a second feature extracted by inputting a multi-modality including a first modality and a second modality sensed by a second sensor to a teacher model. The neural network model may be the above-described student model. The neural network model may be learned by repeatedly back-propagating the cross-correlation loss that causes a first correlation between the first feature vector and the second feature vector to be greater than a reference value when the dimension of the first feature vector and the dimension of the second feature vector are the same and a second correlation between the first feature vector and the second feature vector to be less than the reference value when the dimension of the first feature vector and the dimension of the second feature vector are different. The first modality and the second modality may be input in synchronization with each other.

Additionally, in addition to the cross-correlation loss, the neural network model may be learned by repeatedly back-propagating at least one of first GT loss between a first output instance of the neural network model and a first GT instance corresponding to the first modality or second GT loss between a second output instance of the teacher model and a second GT instance corresponding to the multi-modality.

The generation apparatus may extract, for example, a feature vector defined by the encoder from a camera image and estimate a vector map recognition result (e.g., a map element class, direction, location) through a decoder layer and the prediction head 630. As described above, when the decoder layer exists, the prediction head 630 may receive the decoded result from the decoder layer and estimate the vector map recognition result. The prediction head 630 may estimate, for example, what labels the class and point regression branch have, which are the classification results of components of the vectorization map, where the point exists, and what direction the class and point regression branch has.

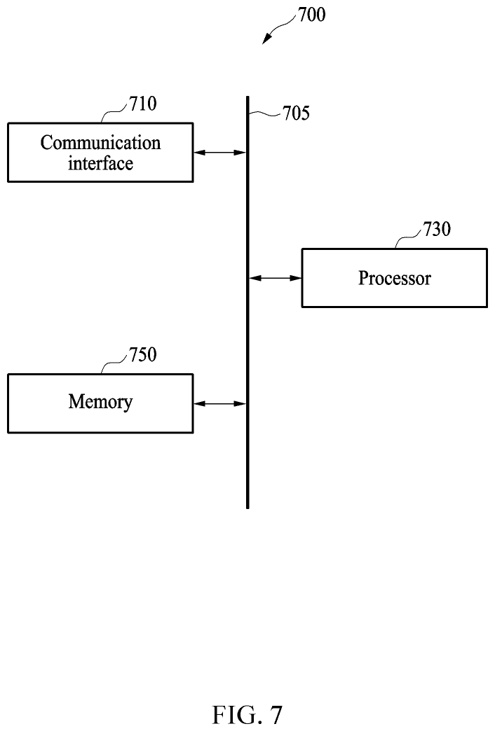

FIG. 7 illustrates an example of a generation apparatus a vector map. Referring to FIG. 7, a generation apparatus 700 may include a communication interface 710, a processor 730, and a memory 750. The communication interface 710, the processor 730, and the memory 750 may communicate with each other via a communication bus 705.

The communication interface 710 may receive a first modality sensed by a first sensor.

The processor 730 may convert a first feature extracted from the first modality received by the communication interface 710 into a first feature vector in a BEV space. The processor 730 may generate a vector map corresponding to the first modality by applying the first feature vector to a learned neural network model. Here, the neural network model may be learned based on cross-correlation loss by dimension, which causes the first feature vector to replicate a correlation with a second feature vector corresponding to a second feature extracted by inputting a multi-modality including the first modality and a second modality sensed by a second sensor to a teacher model.

The neural network model may be learned by repeatedly back-propagating the cross-correlation loss that causes a first correlation between the first feature vector and the second feature vector to be greater than a reference value when the dimension of the first feature vector and the dimension of the second feature vector are the same and a second correlation between the first feature vector and the second feature vector to be less than the reference value when the dimension of the first feature vector and the dimension of the second feature vector are different. The reference value may be, for example, 0.5 but is not necessarily limited thereto.

Additionally, in addition to the cross-correlation loss, the neural network model may be learned by repeatedly back-propagating at least one of first GT loss between a first output instance of the neural network model and a first GT instance corresponding to the first modality or second GT loss between a second output instance of the teacher model and a second GT instance corresponding to the multi-modality.

The memory 750 may store at least one of the cross-correlation loss by dimension, the first GT loss, or the second GT loss calculated by the processor 730.

Alternatively, the memory 750 may store parameters of a pre-learned neural network model (e.g., a teacher model). The processor 730 may generate a vector map using a neural network model to which the parameters stored in the memory 750 are applied. In addition, the memory 750 may store various types of data and programs. The memory 750 may include a volatile memory or a non-volatile memory. The memory 750 may store a variety of data by including a large mass storage medium, such as a hard disk.

In addition, the processor 730 may perform at least one method described with reference to FIGS. 1 to 6 or an algorithm corresponding to the at least one method. The processor 730 may be a data processing device implemented by hardware including a circuit having a physical structure to perform desired operations. The desired operations may include, for example, code or instructions included in a program. The processor 730 may be implemented as, for example, a central processing unit (CPU), a graphics processing unit (GPU), or a neural network processing unit (NPU). A hardware-implemented generation apparatus (e.g., the generation apparatus 700) may include, for example, a microprocessor, a CPU, a processor core, a multi-core processor, a multiprocessor, an application-specific integrated circuit (ASIC), and a field-programmable gate array (FPGA).

The processor 730 may execute a program and may control the generation apparatus 700. Code (instructions) of the program to be executed by the processor 730 may be stored in the memory 750.

The computing apparatuses, the electronic devices, the processors, the memories, the sensors, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A model learning method of generating a vector map, the method performed by one or more processors, the learning method comprising:
extracting a first feature by inputting a first modality sensed by a first sensor to a student model that infers the first feature from the first modality, and converting the first feature into a first feature vector in a bird's eye view (BEV) space;
extracting a second feature extracted by inputting a multi-modality to a teacher model that infers the second feature from the modality, and converting the second feature into a second feature vector in the BEV space, wherein the multi-modality comprises the first modality and a second modality sensed by a second sensor; and
teaching the student model to generate a vector map corresponding to the first modality by back-propagating cross-correlation loss by dimension, which causes the first feature vector to replicate a cross-correlation with the second feature vector to the student model.

2. The model learning method of claim 1, wherein the teaching of the student model comprises repeatedly back-propagating the cross-correlation loss that causes
a first correlation between the first feature vector and the second feature vector to be greater than a reference value in response to a dimension of the first feature vector and a dimension of the second feature vector being the same and that causes
a second correlation between the first feature vector and the second feature vector to be less than the reference value in response to the dimension of the first feature vector and the dimension of the second feature vector being different.

3. The model learning method of claim 1, wherein the teaching of the student model further comprises repeatedly back-propagating either (i) a first ground truth (GT) loss between a first output instance of the student model and a first GT instance corresponding to the first modality or (ii) a second GT loss between a second output instance of the teacher model and a second GT instance corresponding to the multi-modality to the student model.

4. The model learning method of claim 1, further comprising:
augmenting the first feature vector or the second feature vector,
wherein the teaching of the student model comprises back-propagating the cross-correlation loss by dimension to the student model so that the augmented first feature vector replicates a cross-correlation with the augmented second feature vector.

5. The model learning method of claim 4, wherein the augmenting comprises augmenting the first feature vector or the second feature vector using a drop-out layer or random Gaussian noise.

6. The model learning method of claim 4, wherein the back-propagating of the cross-correlation loss by dimension to the student model comprises:
first-concatenating the first feature vector with the augmented first feature vector;
second-concatenating the second feature vector with the augmented second feature vector; and
back-propagating the cross-correlation loss by dimension to the student model so that the first-concatenated feature vector replicates a cross-correlation with the second-concatenated feature vector.

7. The model learning method of claim 1, wherein each of the first feature vector and the second feature vector comprises a row corresponding to the dimension and a column corresponding to an instance.

8. The model learning method of claim 1, wherein the first modality and the second modality are input in synchronization with each other.

9. The model learning method of claim 1, wherein
the first sensor comprises a camera sensor, and
the second sensor comprises a lidar sensor.

10. A method, performed by one or more processors, of generating a vector map, the method comprising:
accessing a first modality sensed by a first sensor;
extracting a first feature from the first modality and converting the first feature into a first feature vector in a bird's eye view (BEV) space; and
generating the vector map, which corresponds to the first modality, by applying the first feature vector to a learned neural network model,
wherein the neural network model has been learned based on cross-correlation loss by dimension, which causes the first feature vector to replicate a cross-correlation with a second feature vector corresponding to a second feature extracted by inputting, to a teacher model, a multi-modality comprising the first modality and a second modality sensed by a second sensor.

11. The method of claim 10, wherein the neural network model is learned by repeatedly back-propagating the cross-correlation loss, which causes a first correlation between the first feature vector and the second feature vector to be greater than a reference value, in response to a dimension of the first feature vector and a dimension of the second feature vector being the same and a second correlation between the first feature vector and the second feature vector to be less than the reference value in response to the dimension of the first feature vector and the dimension of the second feature vector being different.

12. The method of claim 10, wherein the neural network model is further learned by repeatedly back-propagating either (i) a first ground truth (GT) loss between a first output instance of the neural network model and a first GT instance corresponding to the first modality or (ii) a second GT loss between a second output instance of the teacher model and a second GT instance corresponding to the multi-modality.

13. The method of claim 10, wherein the first modality and the second modality are input in synchronization with each other.

14. The method of claim 10, wherein
the first sensor comprises a camera sensor, and
the second sensor comprises a lidar sensor.

15. The method of claim 10, wherein each of the first feature vector and the second feature vector comprises a row corresponding to the dimension and a column corresponding to an instance.

16. The method of claim 1, wherein the first modality comprises a color image and the second modality comprises a point cloud.

17. An apparatus for generating a vector map, the apparatus comprising:
one or more processors; and
memory storing instructions configured to cause the one or more processors to:
convert a first feature extracted from a first modality into a first feature vector in a bird's eye view (BEV) space, and
generate a vector map corresponding to the first modality by applying the first feature vector to a learned neural network model,
wherein the neural network model has been learned based on cross-correlation loss by dimension, which causes the first feature vector to replicate a cross-correlation with a second feature vector corresponding to a second feature extracted by inputting, to a teacher model, a multi-modality comprising the first modality, which is sensed by a first sensor, and comprising a second modality sensed by a second sensor.

18. The apparatus of claim 17, wherein the neural network model is learned by repeatedly back-propagating the cross-correlation loss, which causes (i) a first correlation between the first feature vector and the second feature vector to be greater than a reference value in response to a dimension of the first feature vector and a dimension of the second feature vector being the same and causes (ii) a second correlation between the first feature vector and the second feature vector to be less than the reference value in response to the dimension of the first feature vector and the dimension of the second feature vector being different.

19. The apparatus of claim 17, wherein the neural network model, in addition to the cross-correlation loss, is learned by repeatedly back-propagating either (i) first ground truth (GT) loss between a first output instance of the neural network model and a first GT instance corresponding to the first modality or (ii) a second GT loss between a second output instance of the teacher model and a second GT instance corresponding to the multi-modality.

20. The apparatus of claim 17, wherein
the first sensor comprises a camera sensor, and
the second sensor comprises a lidar sensor.
